(19) United States
(12) Patent Application Publication
(10) Pub. No.: US 2026/0034888 A1
(43) Pub. Date: Feb. 5, 2026

(54) ELECTRIFIED VEHICLE

(71) Applicant: TOYOTA JIDOSHA KABUSHIKI KAISHA, Toyota-shi (JP)

(72) Inventor: Hiroaki TOYODA, Mishima-shi (JP)

(73) Assignee: TOYOTA JIDOSHA KABUSHIKI KAISHA, Toyota-shi (JP)

(21) Appl. No.: 19/086,652

(22) Filed: Mar. 21, 2025

(30) Foreign Application Priority Data
Aug. 5, 2024 (JP) 2024-129154

(51) Int. Cl. B60L 3/00; B60L 50/51

(52) U.S. Cl. CPC B60L 3/003; B60L 50/51; B60L 2210/42; B60L 2240/526

(57) ABSTRACT

Electrified vehicle includes a power storage device, a traction motor with three-phase open windings, a power conversion device connected to one end of the open winding of the three-phase with the power storage device being connected to the connected power line, and a first inverter connected to the first and first lower arms of the three-phase open winding, and is connected to the other end of the three-phase open winding with being connected to the power line, and a second inverter that has the second and second upper arms of the three-phase open winding, a switch, and a control device that controls the first, second inverter and switches. When a short-circuit fault of one phase of the first inverter occurs, the control device turns on the switch and stops the one phase of the first and second inverters, and switches and drives the two phases excluding the one phase.

### CROSS-REFERENCE TO RELATED APPLICATION

This application claims priority to Japanese Patent Application No. 2024-129154 filed on Aug. 5, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

Conventionally, an electrified vehicle including a battery (power storage device), a traction motor having a three-phase open winding, and a power conversion device that is connected to the battery and the motor has been proposed (e.g., see Japanese Unexamined Patent Application Publication No. 2018-14829 (JP 2018-14829 A)). The power conversion device of this electrified vehicle includes a first inverter, a second inverter, and a switch. The first inverter is connected to a power line to which the battery is connected, and is connected to one end side of the three-phase open winding, and also has a first upper arm and a first lower arm for three phases. The second inverter is connected to the power line and is connected to the other end side of the three-phase open winding, and also has a second upper arm and a second lower arm for three phases. The switch is provided on the power line between the battery and the first inverter, and the second inverter.

### SUMMARY

In the above-described electrified vehicle, there is a problem in how to limp home when a fault occurs in the power conversion device.

The electrified vehicle according to the present disclosure enables limping home when a fault occurs in the power conversion device.

In order to achieve the above, the electrified vehicle according to the present disclosure adopts the following measures.

A first electrified vehicle according to the present disclosure includes
a power storage device,
a traction motor that includes a three-phase open winding,
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter, and
a control device for controlling the power conversion device, in which
when a short-circuit fault of one phase of the first inverter occurs, the control device turns the switch to an on state and also stops the one phase of the first and second inverters, and performs switching driving of two phases excluding the one phase.

In the first electrified vehicle according to the present disclosure, when a short-circuit fault of one phase of the first inverter occurs, the switch is turned to the on state, and the one phase (the faulty phase) of the first and second inverters is stopped, and switching driving of the two phases (the two normal phases) excluding the one phase is performed. Thus, when a short-circuit fault of one phase of the first inverter occurs, limping home can be performed by rotationally driving the motor.

A second electrified vehicle according to the present disclosure includes
a power storage device,
a traction motor that includes a three-phase open winding,
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter, and
a control device for controlling the power conversion device, in which
when an opening fault of one phase of the first inverter occurs, the control device turns the switch to an on state and also stops the one phase of the first and second inverters, and performs switching driving of two phases excluding the one phase, or turns the switch to an off state and also stops the one phase of the first and second inverters, turns the two phases of one of the second upper arm and the second lower arm of the second inverter to an on state and turns the other to an off state, and performs switching driving of the two phases of the first inverter.

In the second electrified vehicle according to the present disclosure, when an opening fault of one phase of the inverter occurs, the switch is turned to the on state and also the one phase (the faulty phase) of the first and second inverters is stopped, and switching driving of the two phases (the normal two phases) excluding the one phase is performed, or the switch is turned to the off state and also the one phase (the faulty phase) of the first and second inverters is stopped, the two phases (the normal two phases) of one of the second upper arm and the second lower arm of the second inverter are turned to the on state and the other to the off state, and switching driving of the two phases (the normal two phases) of the first inverter is performed. Accordingly, when an opening fault of one phase of the first inverter occurs, limping home can be performed by rotationally driving the motor.

A third electrified vehicle according to the present disclosure includes
a power storage device,
a traction motor that includes a three-phase open winding,
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter, and
a control device for controlling the power conversion device, in which
when a fault of one phase of the second inverter occurs or when an opening fault of the switch occurs, the control device turns the switch to an off state and also turns one of the second upper arm and the second lower arm for the three phases of the second inverter to an on state, turns the other to an off state, and performs switching driving of the three phases of the first inverter.

In the third electrified vehicle according to the present disclosure, when a fault of one phase of the second inverter occurs or when an opening fault of the switch occurs, the switch is turned to an off state and also one of the second upper arm and the second lower arm for the three phases of the second inverter is turned to an on state and the other to an off state, and switching driving of the three phases of the first inverter is performed. Accordingly, when a fault of one phase of the second inverter or an opening fault of the switch occurs, limping home can be performed by rotationally driving the motor.

In this case, when a short-circuit fault of the second upper arm of the one phase or an opening fault of the second lower arm of the one phase occurs, the control device may turn the second upper arm for the three phases to the on state, and when an opening fault of the second upper arm of the one phase or a short-circuit fault of the second lower arm of the one phase occurs, the control device may turn the second lower arm for the three phases to the on state.

A fourth electrified vehicle according to the present disclosure includes
a power storage device,
a traction motor that includes a three-phase open winding,
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter, and
a control device for controlling the power conversion device, in which
when a short-circuit fault of the switch occurs, the control device performs switching driving of the three phases of the first and second inverters.

In the fourth electrified vehicle according to the present disclosure, when a short-circuit fault of the switch occurs, switching driving of the three phases of the first and second inverters is performed. Accordingly, when a short-circuit fault of the switch occurs, limping home can be performed by rotationally driving the motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 10 according to an embodiment of the present disclosure;

FIG. 2 is an explanatory diagram illustrating an exemplary relation between the faulty contents generated in the power conversion device 20 and the control contents of the first and second inverters 22 and 24, the positive-side switch 34p, and the negative-side switch 34n at that time;

FIG. 3 is an explanatory diagram illustrating an example of the control contents of the case 1;

FIG. 4 is an explanatory diagram illustrating an example of the control contents of the case 5;

FIG. 5 is an explanatory diagram illustrating an example of the control content of the modification example in the case 2; and

FIG. 6 is a schematic configuration diagram of a battery electric vehicle 110 according to a modification.

### DETAILED DESCRIPTION OF EMBODIMENTS

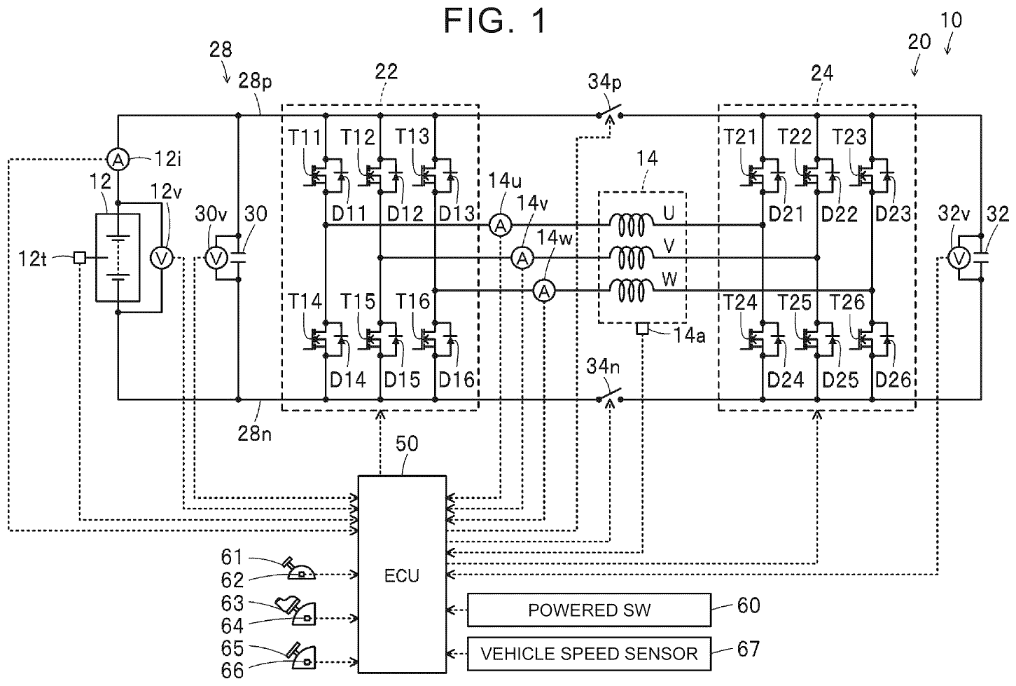

Embodiments for carrying out the present disclosure will be described with reference to the drawings. FIG. 1 is a schematic configuration diagram of a battery electric vehicle 10 according to an embodiment of the present disclosure. As illustrated, battery electric vehicle 10 of the embodiment includes a battery 12 as a power storage device, a motor 14, and a power conversion device 20 connected to a power line 28 (a positive-side line 28p and a negative-side line 28n) to which the battery 12 is connected, and connected to the motor 14. Battery electric vehicle 10 of the embodiment further includes an electronic control unit (hereinafter referred to as “ECU”) 50 as a control device that controls the entire vehicle.

The battery 12 is configured as, for example, a lithium-ion secondary battery or a nickel-hydrogen secondary battery, and is connected to the power line 28 (the positive-side line 28p and the negative-side line 28n). The motor 14 is configured as a three-phase AC motor, and includes a rotor in which permanent magnets are embedded in a rotor core, and a stator in which coils (open windings) of three phases (U-phase, V-phase, and W-phase) are wound around the stator core. The rotor is connected to a drive shaft connected to the drive wheels via a differential gear.

The power conversion device 20 includes a first inverter 22, a second inverter 24, a positive-side switch 34p, and a negative-side switch 34n. The first inverter 22 includes six transistors T11 to T16 as switching elements, and six diodes D11 to D16 connected in parallel to each of the six transistors T11 to T16. The transistors T11 to T16 are arranged two each in pairs so as to be on the source-side and the sink-side with respect to the positive-side line 28p and the negative-side line 28n, respectively. Each of the connecting points of the two transistors that are the pair of the transistors T11 to T16 is connected to one end of the three-phase coil of the motor 14. Hereinafter, each of the transistors T11 to T13 may be referred to as a “first upper arm”, and each of the transistors T14 to T16 may be referred to as a “first lower arm”. A smoothing capacitor 30 is connected to the vicinity of the first inverter 22 in the power line 28.

Like the first inverter 22, the second inverter 24 includes six transistors T21 to T26 as switching elements and six diodes D21 to D26. The transistors T21 to T26 are arranged two each in pairs so as to be on the source-side and the sink-side with respect to the positive-side line 28p and the negative-side line 28n, respectively. Each of the connecting points of the two transistors that are the pair of the transistors T21 to T26 is connected to the other end of the three-phase coil of the motor 14. Hereinafter, each of the transistors T21 to T23 may be referred to as a “second upper arm”, and each of the transistors T24 to T26 may be referred to as a “second lower arm”. A smoothing capacitor 32 is connected to the vicinity of the second inverter 24 in the power line 28. In the embodiment, the battery 12, the capacitor 30, the first inverter 22, the second inverter 24, and the capacitor 32 are connected to the power line 28 in this order.

The positive-side switch 34p and the negative-side switch 34n are provided between the battery 12, the capacitor 30, the first inverter 22, the second inverter 24, and the capacitor 32 in the positive-side line 28p and the negative-side line 28n, respectively.

ECU50 includes a microcomputer having a CPU, ROM, RAM, a flash memory, an input/output port, and a communication port, various driving circuitry, and various logic IC. ECU50 receives signals from various sensors. For example, the rotational position θm of the rotor of the motor 14 from the rotational position sensor 14a and the phase current Iu,Iv,Iw of each phase of the motor 14 from the current sensor 14u,12v,12w are inputted. The voltage Vb of the battery 12 from the voltage sensor 12v, the current Ib of the battery 12 from the current sensor 12i, and the temperature Tb of the battery 12 from the temperature sensor 12t are also inputted. A voltage VH of the capacitor 30 (the DC side of the first inverter 22) from the voltage sensor 30v and a voltage VL of the capacitor 32 (the DC side of the second inverter 24) from the voltage sensor 32v are also inputted. An on-off signal from the power switch 60, an operating position (shift position SP) of the shift lever 61 from the shift position sensor 62, and a depression amount (accelerator operation amount Acc) of the accelerator pedal 63 from the accelerator pedal position sensor 64 are also inputted. The amount of depression of the brake pedal 65 (brake pedal position BP) from the brake pedal position sensor 66 and the vehicle speed V from the vehicle speed sensor 67 are also inputted.

From ECU50, control signals are outputted from the transistor T11 of the first inverter 22 to T16, and from the transistor T21 of the second inverter 24 to T26, the positive-side switch 34p, and the negative-side switch 34n. ECU50 calculates the electric angle θe and the rotational speed Nm of the motor 14 based on the rotational position Om of the rotor of the motor 14, and calculates the power storage ratio SOC of the battery 12 based on the integrated value of the current Ib of the battery 12.

In battery electric vehicle 10 of the embodiment, ECU50 sets a required torque Td* required for traveling based on the accelerator operation amount Acc and the vehicle speed V, and sets a torque command Tm* of the motor 14 so as to travel according to the set required torque Td*. ECU50 basically performs three-phase Y-drive or three-phase H-drive based on the set torque-command Tm*. In the three-phase Y drive, the positive-side switch 34p and the negative-side switch 34n are turned off. Further, in the three-phase Y driving, one of the third-phase second upper arm (T23 from the transistor T21) and the third-phase second lower arm (T26 from the transistor T24) of the second inverter 24 is turned on and the other is turned off, and the three-phase (T16 from the transistor T11) of the first inverter 22 is switched and driven. In this case, the U-phase, the V-phase, and the W-phase of the motor 14 are coupled to each other at a neutral point by the second inverter 24. In the three-phase H drive, the positive-side switch 34p and the negative-side switch 34n are turned on, and three phases (from the transistor T11 to T16,T21 to T26) of the first and second inverters 22 and 24 are switched and driven.

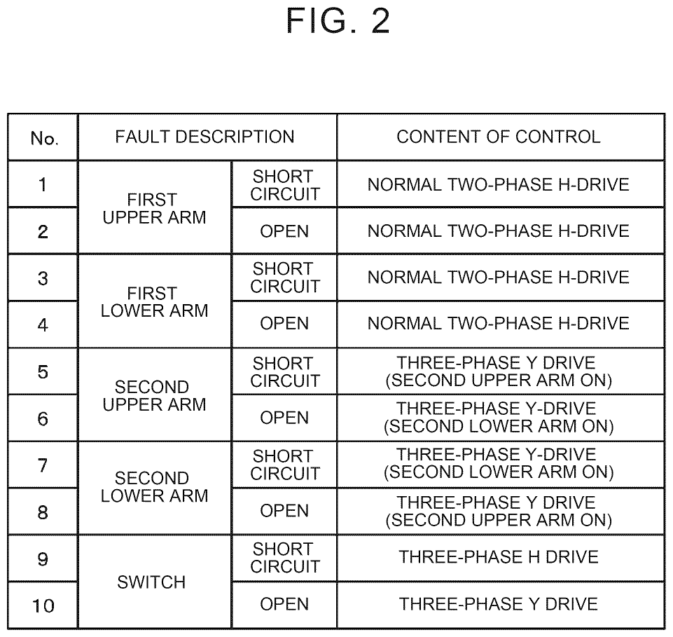

Next, an operation of battery electric vehicle 10 according to the embodiment, in particular, an operation when a fault occurs in the power conversion device 20 will be described. FIG. 2 is an explanatory diagram illustrating an exemplary relation between the faulty contents generated in the power conversion device 20 and the control contents of the first and second inverters 22 and 24, the positive-side switch 34p, and the negative-side switch 34n at that time.

A case where a short-circuit fault occurs in the first upper arm of the one phase of the first inverter 22, as in the case 1, and a case where an opening fault occurs in the first upper arm of the one phase of the first inverter 22, as in the case 2, will be described. A case where a short-circuit fault occurs in the first lower arm of the one phase of the first inverter 22 as in the case 3, and a case where an opening fault occurs in the first lower arm of the one phase of the first inverter 22 as in the case 4 will be described. In these cases, H driving of two phases (normal two phases) excluding one phase (abnormal phase) in which a fault has occurred among the three phases of the first and second inverters 22 and 24 is executed.

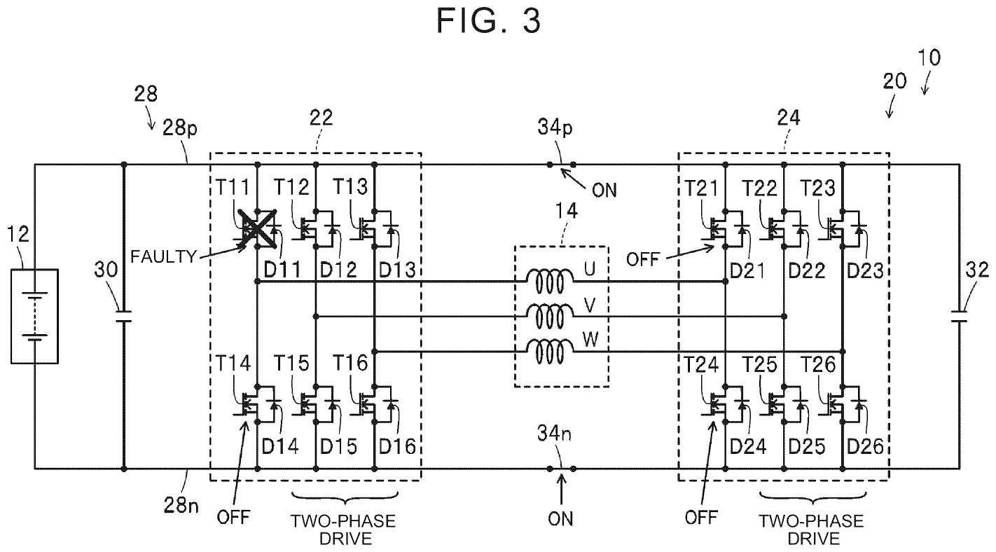

In the normal two-phase H drive in cases 1 to 4, the positive-side switch 34p and the negative-side switch 34n are turned on. Further, in the normal 2-phase H driving in the case 1 to 4, the normal 2-phase switching driving together with stopping the abnormal phase of the first and second inverters 22 and 24 (turning off the arm in which no fault has occurred among the abnormal phases). In this way, the motor 14 can be rotationally driven to perform limping home. FIG. 3 is an explanatory diagram illustrating an example of control contents of the case 1. As shown in FIG. 3, when a short-circuit fault occurs in the transistor T11 (the U-phase first upper arm), the positive-side switch 34p and the negative-side switch 34n are turned on and the transistor T11,T14,T21,T24 is turned off. At the same time, the transistor T12,T13,T15,T16,T22,T23,T25,T26 is switched and driven.

A case where a short-circuit fault occurs in the one phase second upper arm of the second inverter 24, as in the case 5, and a case where an opening fault occurs in the one phase second upper arm of the second inverter 24, as in the case 6, will be described. A case where a short-circuit fault occurs in the one phase second lower arm of the second inverter 24, as in the case 7, and a case where an opening fault occurs in the one phase second lower arm of the second inverter 24, as in the case 8, will be described. In these cases, three-phase Y-drive is performed.

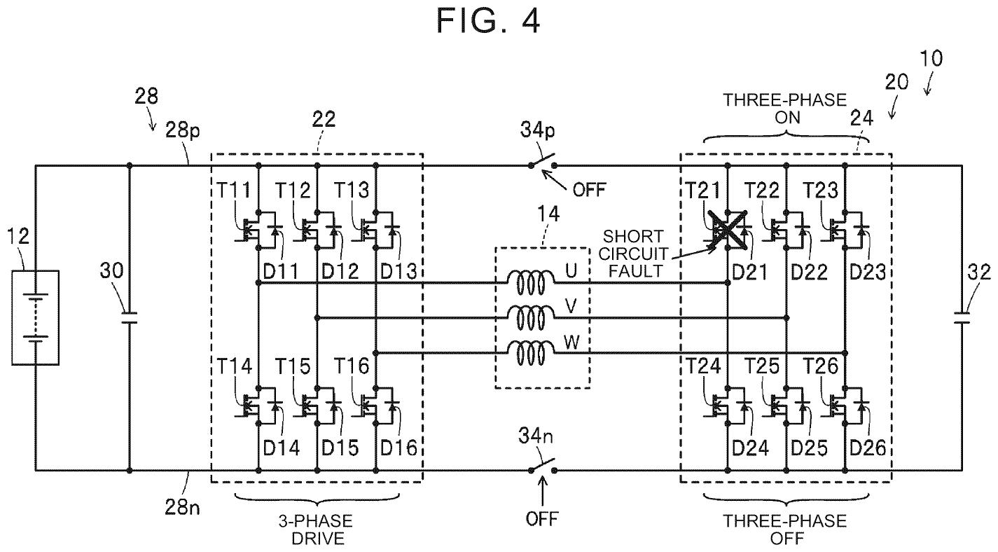

In the three-phase Y-drive in the cases 5 and 8, the positive-side switch 34p and the negative-side switch 34n are turned off. Further, in the three-phase Y drive in the case 5 and 8, the second upper arm of the three phases of the second inverter 24 is turned on and the second lower arm of the three phases is turned off, and the three phases of the first inverter 22 are switched and driven. In this way, the motor 14 can be rotationally driven to perform limping home. FIG. 4 is an explanatory diagram illustrating an example of control contents of the case 5. As shown in FIG. 4, when a short-circuit fault occurs in the transistor T21 (U-phase second upper arm), the positive-side switch 34p and the negative-side switch 34n are turned off and the transistor TT22,T23 is turned on. At the same time, T26 is turned off from the transistor T24, and T16 is switched and driven from the transistor T11.

In the three-phase Y drive in the cases 6 and 7, the positive-side switch 34p and the negative-side switch 34n are turned off, and the second lower arm of the three phases of the second inverter 24 is turned on. At the same time, the second upper arm of the three phases is turned off, and the three phases of the first inverter 22 are switched and driven. In this way, the motor 14 can be rotationally driven to perform limping home. For example, when an opening fault of the transistor T21 (U-phase second upper arm) occurs, the positive-side switch 34p and the negative-side switch 34n are turned off, and T26 is turned on from the transistor T24. At the same time, T23 is turned off from the transistor T21, and T16 is switched and driven from the transistor T11.

When any one of the positive-side switch 34p and the negative-side switch 34n is short-circuited fault as in the case 9, the three-phase H drive is executed. In the three-phase H drive, the positive-side switch 34p and the negative-side switch 34n are turned on, and three phases of the first and second inverters 22 and 24 are switched and driven. In this way, the motor 14 can be rotationally driven to perform limping home.

When any one of the positive-side switch 34p and the negative-side switch 34n is opened faulty as in the case 10, three-phase Y driving is performed. In the three-phase Y drive in this case, the positive-side switch 34p and the negative-side switch 34n are turned off. Furthermore, in the three-phase Y drive in this case, one of the third-phase second upper arm and the third-phase second lower arm of the second inverter 24 is turned on and the other is turned off, and the three phases of the first inverter 22 are switched and driven. In this way, the motor 14 can be rotationally driven to perform limping home.

In battery electric vehicle 10 of the above-described embodiment, as in the cases 1 to 4, when a fault (a short-circuit fault or an opening fault) occurs in the first upper arm or the first lower arm of the one phase of the first inverter 22, H driving of the normal two phases is executed. When a fault (a short-circuit fault or an opening fault) occurs in the second upper arm or the second lower arm of the one phase of the second inverter 24 as in the cases 5 to 8, the three-phase Y drive is executed. When any one of the positive-side switch 34p and the negative-side switch 34n is short-circuited fault as in the case 9, the three-phase H drive is executed. When any one of the positive-side switch 34p and the negative-side switch 34n is opened faulty as in the case 10, three-phase Y driving is performed. In this manner, the motor 14 can be rotationally driven to perform limping home.

In the above-described embodiment, as shown in FIG. 2, for each of the cases 1 to 10, the motor 14 is rotationally driven by controlling the first and second inverters 22 and 24, the positive-side switch 34p, and the negative-side switch 34n, and limping home is performed. However, the limping home may be performed only when a part of the cases 1 to 10 is generated.

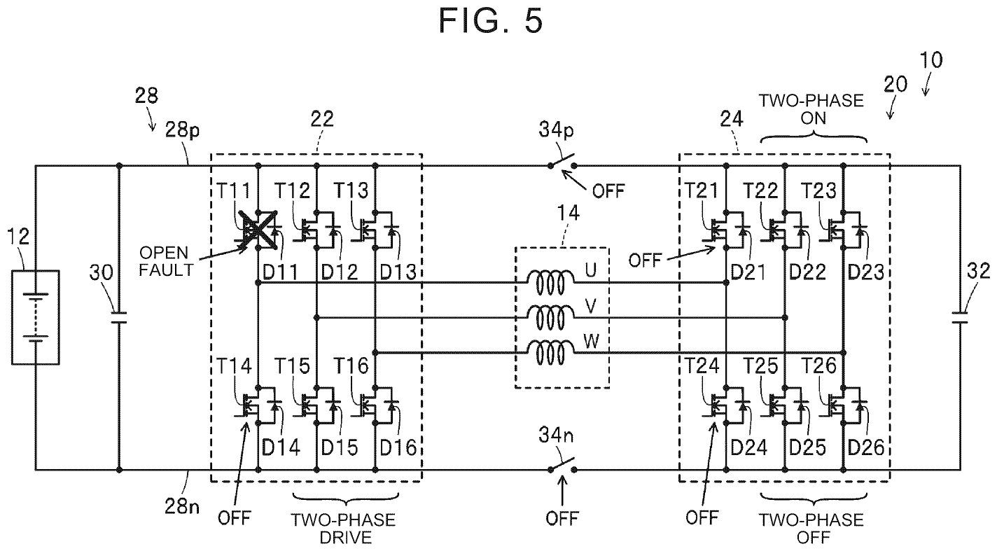

In the above-described embodiment, when an opening fault occurs in the first upper arm or the first lower arm of the one phase of the first inverter 22 as in the cases 2 and 4, the H drive of the normal two phases is executed, but the present disclosure is not limited thereto. For example, in the case of the cases 2 and 4, the normal two-phase Y drive may be executed. In the normal two-phase Y drive in cases 2 and 4, the positive-side switch 34p and the negative-side switch 34n may be in the off-state, and the abnormal phases of the first and second inverters 22 and 24 may be stopped (an arm in which no fault occurs in the abnormal phase may be in the off-state). Furthermore, in the normal two-phase Y drive in the case 2, 4, one of the second upper arm and the second lower arm of the normal two-phase of the second inverter 24 may be turned on and the other may be turned off, and the normal two-phase of the first inverter 22 may be switched and driven. Even in this manner, the motor 14 can be rotationally driven to perform limping home. FIG. 5 is an explanatory diagram illustrating an example of the control content of the present modification example in the case 2. As shown in FIG. 5, when an opening fault of the transistor T11 occurs, the positive-side switch 34p and the negative-side switch 34n may be turned off, and the transistor T14,T21,T24 may be turned off. Alternatively, one of the transistor T22,T23 and the transistor T25,T26 may be turned on and the other may be turned off, and the transistor T12,T13,T15,T16 may be switched and driven.

In the above-described embodiment, when a fault (a short-circuit fault or an opening fault) occurs in the second upper arm or the second lower arm of the one phase of the second inverter 24 as in the cases 5 to 8, the three-phase Y drive is executed, but the present disclosure is not limited thereto. For example, in the case of cases 5 to 8, H driving of the normal two phases may be performed. In the normal two-phase H drive in the case 5 to 8, the positive-side switch 34p and the negative-side switch 34n may be turned on in the same manner as in the normal two-phase H drive in the case 1 to 4. Further, in the normal 2-phase H driving in the case 5 to 8, the normal 2-phase may be switched driving together with stopping the abnormal phases of the first and second inverters 22 and 24 (turning off the arm in which no fault has occurred among the abnormal phases). Even in this manner, the motor 14 can be rotationally driven to perform limping home.

In the above-described embodiment, when the opening fault of the first-phase second upper arm or the second lower arm of the second inverter 24 occurs as in the cases 6 and 8, the three-phase Y drive is executed, but the present disclosure is not limited thereto. For example, in the case of the cases 6 and 8, the normal two-phase Y drive may be executed. In the normal two-phase Y drive in cases 6 and 8, the positive-side switch 34p and the negative-side switch 34n may be in the off-state, and the abnormal phases of the first and second inverters 22 and 24 may be stopped (an arm in which no fault occurs in the abnormal phase may be in the off-state). Further, in the normal two-phase Y driving in the case 6, 8, one of the second upper arm and the second lower arm of the normal two phases of the second inverter 24 may be turned on and the other may be turned off, and the normal two phases of the first inverter 22 may be switched and driven. Even in this manner, the motor 14 can be rotationally driven to perform limping home.

In the above-described embodiment, the power conversion device 20 includes the positive-side switch 34p and the negative-side switch 34n, but the present disclosure is not limited thereto. For example, the power conversion device 20 may include only one of the positive-side switch 34p and the negative-side switch 34n. In addition, the power conversion device 20 may include not only one positive-side switch 34p but also a plurality, and may include not only one negative-side switch 34n but also a plurality.

In the above-described embodiment, the battery 12 is used as the power storage device, but a capacitor or the like may be used.

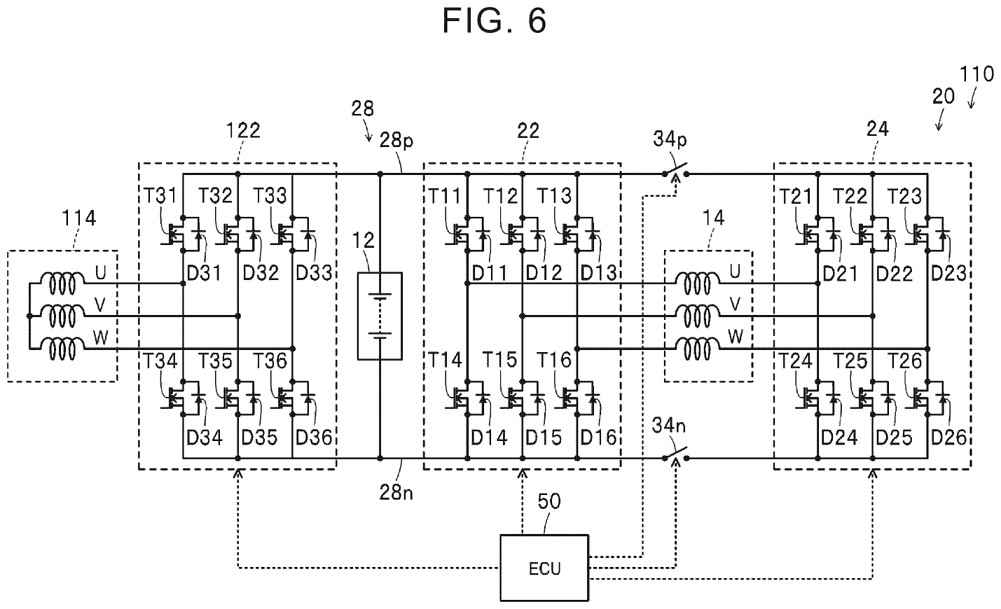

In the embodiment described above, as shown in FIG. 1, battery electric vehicle 10 includes a battery 12, a motor 14 connected to the drive wheels, and a power conversion device 20 connected to the power line 28 to which the battery 12 is connected and connected to the motor 14. However, it is not limited thereto. FIG. 6 is a schematic configuration diagram of a battery electric vehicle 110 according to a modification. Battery electric vehicle 110 of FIG. 6 further includes a second motor 114 connected to the second drive wheel and a third inverter 122 in addition to the hardware configuration similar to battery electric vehicle 10 of FIG. 1. The third inverter 122 is connected to the power line 28 and to the second motor 114. One end of the three-phase coil of the second motor 114 is connected to each other to form a neutral point. Like the first and second inverters 22 and 24, the third inverter 122 includes six transistors T31 to T36 as switching elements and six diodes D31 to D36. The transistors T31 to T36 are arranged two each in pairs so as to be on the source-side and the sink-side with respect to the positive-side line 28p and the negative-side line 28n, respectively. Each of the connecting points of the two transistors that are the pair of the transistors T31 to T36 is connected to the other end of the three-phase coil of the second motor 114.

In battery electric vehicle 110, the same control content as described above may be executed for each of the cases 1 to 10 in FIG. 2. In addition, the three phases of the third inverter 122 may be switched and driven to rotate the second motor 114 with respect to the cases 1 to 10 in addition to the same control contents as described above.

In the above-described embodiment, the configuration of battery electric vehicle 10 including the battery 12, the traction motor 14, and the power conversion device 20 is employed, but the configuration is not limited to this. For example, hybrid electric vehicle may further include an engine in addition to the battery, the motor, and the power conversion device. Fuel cell electric vehicle may further include a fuel-cell in addition to the battery, the motor, and the power conversion device.

The correspondence between the main elements of the embodiments and the main elements of the disclosure described in the column of the means for solving the problem will be described. In the embodiment, the battery 12 corresponds to the “power storage device”, the motor 14 corresponds to the “motor”, the power conversion device 20 corresponds to the “power conversion device”, and ECU50 corresponds to the “control device”. Further, the first inverter 22 corresponds to the “first inverter”, the second inverter 24 corresponds to the “second inverter”, and the positive-side switch 34p and the negative-side switch 34n correspond to the “switch”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an electrified vehicle and the like.

What is claimed is:

1. An electrified vehicle, comprising: a power storage device;
a traction motor that includes a three-phase open winding;
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter; and
a control device for controlling the power conversion device, wherein
when a short-circuit fault of one phase of the first inverter occurs, the control device turns the switch to an on state and also stops the one phase of the first and second inverters, and performs switching driving of two phases excluding the one phase.

2. An electrified vehicle, comprising: a power storage device;
a traction motor that includes a three-phase open winding;
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter; and
a control device for controlling the power conversion device, wherein
when an opening fault of one phase of the first inverter occurs, the control device turns the switch to an on state and also stops the one phase of the first and second inverters, and performs switching driving of two phases excluding the one phase, or turns the switch to an off state and also stops the one phase of the first and second inverters, turns the two phases of one of the second upper arm and the second lower arm of the second inverter to an on state and turns the other to an off state, and performs switching driving of the two phases of the first inverter.

3. An electrified vehicle, comprising: a power storage device;
a traction motor that includes a three-phase open winding;
a power conversion device that includes a first inverter that is connected to a power line to which the power storage device is connected and also is connected to one end side of the three-phase open winding, and also includes a first upper arm and a first lower arm for three phases, a second inverter that is connected to the power line and also is connected to another end side of the three-phase open winding, and also includes a second upper arm and a second lower arm for three phases, and a switch that is provided on the power line, between the power storage device and the first inverter, and the second inverter; and
a control device for controlling the power conversion device, wherein
when a fault of one phase of the second inverter occurs or when an opening fault of the switch occurs, the control device turns the switch to an off state and also turns one of the second upper arm and the second lower arm for the three phases of the second inverter to an on state, turns the other to an off state, and performs switching driving of the three phases of the first inverter.

4. The electrified vehicle according to claim 3, wherein, when a short-circuit fault of the second upper arm of the one phase or an opening fault of the second lower arm of the one phase occurs, the control device turns the second upper arm for the three phases to the on state, and when an opening fault of the second upper arm of the one phase or a short-circuit fault of the second lower arm of the one phase occurs, the control device turns the second lower arm for the three phases to the on state.
